(19) United States
(12) Patent Application Publication
(10) Pub. No.: US 2009/0175993 A1
(43) Pub. Date: Jul. 9, 2009

(54) DIETARY FIBRES

(75) Inventor: Corinda Erasmus, Centurion (ZA)

Correspondence Address: BROOKS KUSHMAN P.C., 1000 TOWN CENTER, TWENTY-SECOND FLOOR, SOUTHFIELD, MI, 48075, US

(73) Assignee: CSIR, Pretoria (ZA)

(21) Appl. No.: 12/373,656

(22) PCT Filed: Jul. 11, 2007
(86) PCT No.: PCT/IB07/52769

§ 371 Date: Mar. 13, 2009

(30) Foreign Application Priority Data
Jul. 14, 2006 (ZA) 2006/05833

(51) Int. Cl. A23J 1/14

(52) U.S. Cl. 426/424

(57) ABSTRACT

A process for obtaining a valuable product from plant material comprising both proteinaceous material and fibrous material includes brushing or scrubbing the plant material in a wet condition in a separation stage against a separation medium, thereby forcing proteinaceous material through the separation medium and retaining fibrous material on the separation medium, and withdrawing a fibre-rich product and a protein-rich product from the separation stage.

THIS INVENTION relates to dietary fibres. In particular, it relates to a process for obtaining a valuable product from plant material.

Dietary fibres are plant-cell-wall polysaccharides and lignin in a food or food ingredient that are not broken down by the digestive enzymes of monogastric animals and humans. Dietary fibre is thus dietary matter that increases faecal bulk. Chemically, total dietary fibre includes cellulose, hemicellulose, pectins, gums, lignin and mucilaginous material. Adequate fibre in the human diet has been shown to be nutritionally important, e.g. in the bread industry, because it permits increasing the bulk of food intake without increasing the calorie content. It also increases the shelf life and moisture retention of cereal products such as bread.

As far as the applicant is aware, most dietary fibre additives are at present produced from wood, bamboo and various seed plant materials including pea hulls, corn hulls, peanut hulls, oat hulls and stems. In view of the importance of dietary fibre, there is a continuing need to find suitable edible sources of dietary fibre and suitable methods of obtaining the dietary fibre.

There is also a need to find new or alternative sources of protein, e.g. to substitute fish meal from overexploited fish resources. Preferably, a protein stream high in protein content should be provided to reduce downstream processing costs, e.g. for the extraction of prolamin or other proteins.

According to one aspect of the invention, there is provided a process for obtaining a valuable product from plant material comprising both proteinaceous material and fibrous material, the process including

in a separation stage, brushing or scrubbing the plant material in a wet condition against a separation medium, thereby forcing proteinaceous material through the separation medium and retaining fibrous material on the separation medium; and

withdrawing a fibre-rich product and a protein-rich product from the separation stage.

By “wet condition” is meant that the plant material is not dried prior to it being scrubbed or brushed, so that the plant material still has a high internal moisture content.

The plant material typically includes predominantly grain, i.e. seeds from cereals and legumes. Preferably, the plant material includes predominantly grain from the grass family and/or from the legume family. In particular, the plant material may be brewer's spent grain, e.g. from any germinated and/or ungerminated grain from the grass family such as barley, sorghum, wheat or maize, or from the legume family such as soybeans.

The process of the invention thus provides a new use for brewer's spent grain, which typically is enriched in protein, fibre and energy once carbohydrates have been removed during the brewing process. Traditionally, the brewer's spent grain is used unmodified as an animal feed with relatively low commercial value. By recovering the dietary fibres and proteins from the brewer's spent grain, the process of the invention adds value to the brewer's spent grain. The Applicant also expects that the process of the invention will work well in wet milling applications which are not brewing related, e.g. maize processing and ethanol manufacturing plants.

The applicant has found that by brushing or combing the plant material in such a wet state or condition, i.e. with a natural or inherent high moisture content in a single-stage process, instead of milling typically pre-dried plant material in a costly multi-step process, the dietary fibre content in a fibrous stream obtained from the plant material improves by up to 40% and the protein content in a high-protein stream obtained from the same plant material improves by up to 70%. A cost-effective one-step method is thus provided to separate the plant material into a fibre-rich product stream and a protein-rich product stream, suitable for further processing. Thus, whereas conventional methods typically provide a wet coarse product containing about 14% by weight of dietary fibres (72% moisture), the process according to the invention typically provides a wet coarse product containing 20% by weight dietary fibres (72% moisture). On a dry base the dietary fibres may increase from about 50% to about 70% or more.

The process may include digesting and bleaching the fibre-rich product. The digesting and bleaching may be effected simultaneously. Digestion is for solubilising residual protein and fat in the fibre-rich product, in order to increase purification levels. The fibre-rich product may thus simultaneously be digested and bleached with an aqueous solution that includes a digesting agent and a bleaching agent. The digesting agent may be an alkali metal hydroxide, e.g. NaOH or KOH or the like. The bleaching agent may be hydrogen peroxide, ozone or sodium hypochlorite.

Advantageously, the digesting and bleaching of the fibre-rich product may be effected at room temperature and at atmospheric pressure. Thus, the digesting and bleaching may advantageously be effected simultaneously in a cold ambient-pressure process, in contrast to the prior art of which the applicant is aware. No stirring is required except when the digesting and bleaching agents are mixed with the fibre-rich product at room temperature (i.e. typically between 15 and 35 degrees Celsius). This is advantageous, because the lack of stirring causes the fibres to remain intact allowing easy downstream filtration and washing of the fibres. This will reduce the need for specialised filtration equipment and will reduce the incidence of clogging of sieves and filters, which is a common problem with prior art processes.

The digesting and bleaching may be effected in two stages, with the fibre-rich product in each stage being simultaneously digested and bleached. The fibre-rich product may be subjected to water washing stages between the two digesting and bleaching stages, and after the last digesting and bleaching stage.

The aqueous solution used for digesting and bleaching may have a pH from about 9 to about 13.5, preferably from about 12 to about 13.5, more preferably from about 12.6 to about 13.05, e.g. about 12.7.

The process may include subjecting the fibre-rich product to additional bleaching stages, by contacting it with a bleaching agent, after the simultaneous digesting and bleaching of the fibre-rich product.

In the additional bleaching stage, the bleaching agent may be a mineral acid, e.g. HCl, an oxidising agent e.g. hydrogen peroxide, ozone or sodium hypochlorite in alkaline medium or an enzyme. The process may include pressing the bleaching agent from the fibre-rich product. If desired, the process may also include washing the fibre-rich product after the additional bleaching stage.

The process may include drying the fibre-rich product and milling the fibre-rich product to a desired particle or fibre size.

The separation medium may be in the form of a hollow perforated cylindrical drum, the plant material being brushed or scrubbed with at least one brush against an interior surface of the hollow perforated cylindrical drum.

Typically, the separation medium has apertures with a maximum dimension (e.g. diameter if the apertures are round) of no more than 3 mm. Preferably, the apertures have a maximum dimension in the range of 0.3 to 3 mm.

The plant material may have a moisture content of at least 70%.

The process may include feeding the plant material into the separation stage as an aqueous feed stream, with the fibre-rich product being withdrawn from the separation stage as an aqueous product stream. The aqueous feed stream may include water obtained from a brewing process, with said water thus forming part of the aqueous product stream. Naturally, any other source of potable water may instead or in addition be used. The water and fibre-rich product of the aqueous product stream may be separated, with the water being added to the protein-rich product.

The invention extends to the use of wet brewer's spent grain to provide a protein-rich product and a fibre-rich product.

The invention also extends to a protein-rich product produced by the process as hereinbefore described.

The protein-rich product may have a protein content of at least 40% by mass on a dry basis. Typically, the protein-rich product has a crude fibre content of less than 8% by mass on a dry basis.

The invention further extends to a fibre-rich product produced by the process as hereinbefore described.

The fibre-rich product may have a dietary fibre content of at least 70% by mass on a dry basis. Typically, the fibre-rich product has a protein content of less than 13% by mass on a dry basis. Once bleached, the fibre-rich product may have a protein content of less than 3% by mass on a dry basis and a fibre content of at least 75% by mass on a dry basis.

Preferably, the fibre-rich product has a pH of from about 5 to about 7. The fibre-rich product may have a water absorption of from about 2 gram water per gram of dry product to about 6 or 7 gram water per gram of dry product, e.g. about 3.2 g/g.

The invention will now be described, by way of example, with reference to the accompanying diagrammatic drawings and the Examples.

In the drawings,

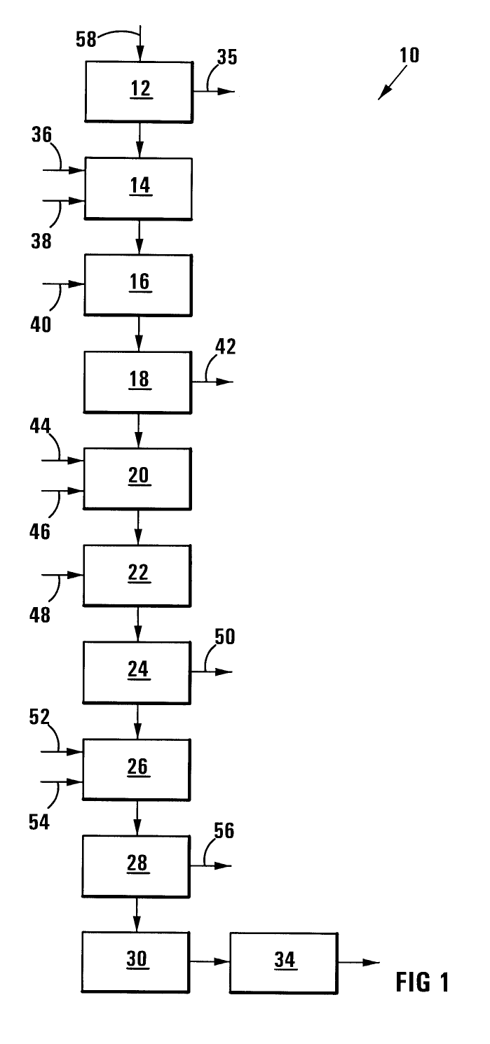

FIG. 1 shows a process in accordance with the invention for obtaining dietary fibres from plant material comprising proteinaceous material and fibrous material;

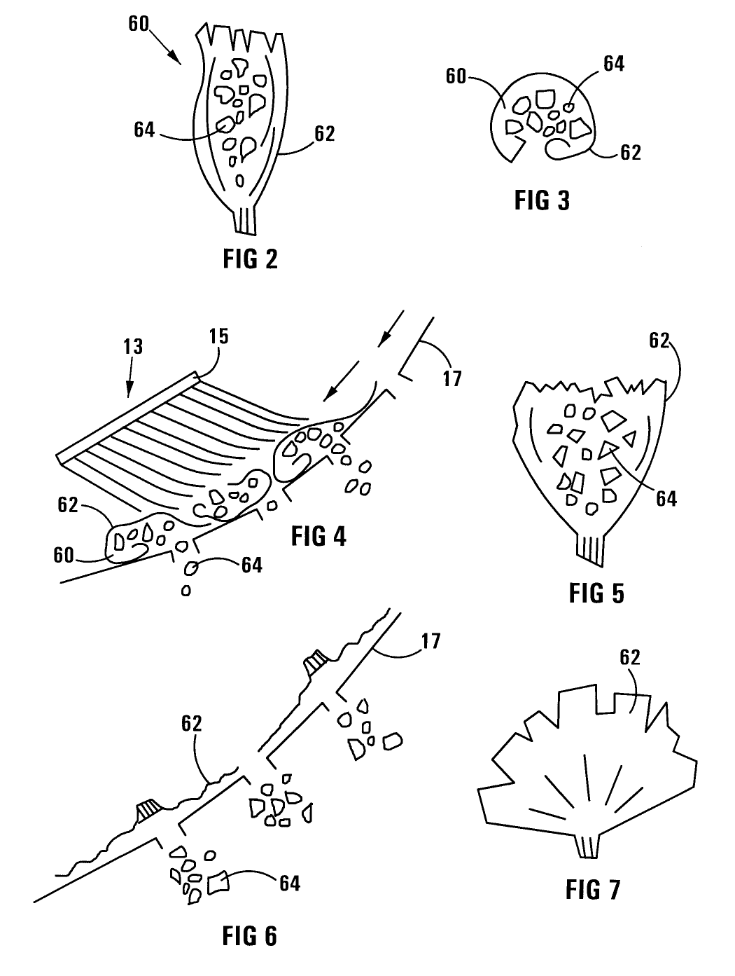

FIG. 2 shows a side view of an intact barley grain particle after the malting and extraction process;

FIG. 3 shows an end view of the particle of FIG. 2;

FIG. 4 shows a portion of a brush pulper, in use;

FIG. 5 shows the particle of FIG. 2, partially opened by the brush pulper of FIG. 4;

FIG. 6 shows the brush pulper of FIG. 4, in use, with the husks of the particles fully opened; and

FIG. 7 shows the fully opened husk as it exits from the drum of the brush pulper of FIG. 6.

Referring to FIG. 1 of the drawings, reference numeral 10 generally indicates a process in accordance with the invention for obtaining dietary fibres and proteinaceous material from plant material comprising proteinaceous material and fibrous material. The process 10 includes a separation or brushing stage 12 followed by a first digesting and bleaching stage 14. A sodium hydroxide line 36 and a hydrogen peroxide line 38 lead into the first digesting and bleaching stage 14.

The first digesting and bleaching stage 14 is followed by a first washing stage 16 and a first liquid removal stage 18. A water feed line 40 leads into the first washing stage 16 and a liquid removal line 42 leads from the first liquid removal stage 18.

The first liquid removal stage 18 is followed by a second digesting and bleaching stage 20, a second washing stage 22, a second liquid removal stage 24, a neutralising stage 26, a third liquid removal stage 28, a drying stage 30 and a milling stage 34. A sodium hydroxide line 44 and a hydrogen peroxide line 46 lead into the second digesting and bleaching stage 20. A water feed line 48 leads into the second washing stage 22 and a liquid removal line 50 leads from the second liquid removal stage 24. A water feed line 52 and a hydrochloric acid feed line 54 lead into the neutralising stage 26. A liquid removal line 56 leads from the third liquid removal stage 28.

Wet brewer's spent grain obtained from a brewing operation as is (without additional pre-treatment) is fed to the brushing stage 12 as shown by line 58. An intact grain particle 60 forming part of the spent grain is shown in FIGS. 2 and 3 of the drawings. The particle 60 includes a husk or glume 62 and inner, proteinaceous material 64, which is partially exposed. In the brushing stage 12, a brush pulper 13 (see FIG. 4) comprising a rotating brush 15 located inside a perforated cylindrical drum 17 is used to separate the brewer's spent grain into a proteinaceous fraction comprising the material 64 and a fibrous fraction comprising the fully opened husks 62 (see FIG. 7). Such brush pulpers are commonly used to pulp fruit purely for producing pulp for use in juice manufacture, but to the best of the Applicant's knowledge, the use of brush pulpers or similar brushing techniques to separate brewer's spent grain or similar material from cereals is not known. The proteinaceous fraction is brushed from the fibrous fraction and pressed through the perforated cylindrical drum 17 (with a maximum perforation size of 2 mm) (see FIGS. 4 to 7) with the fibrous fraction comprising the fully opened, cleaned husks 62 being fed axially through the drum to the first digesting and bleaching stage 14. The proteinaceous fraction, removed from the brushing stage 12 by line 35, can be used as animal feed or worked up into other value added products, as final protein content of the dried proteinaceous fraction is typically more than 40%, which compares well with protein content from other sources such as oil cakes from, for example, soybeans or sunflower, or fish meal.

In the first digesting and bleaching stage 14, sodium hydroxide and hydrogen peroxide are added to the fibrous fraction by means of the lines 36 and 38 respectively and thoroughly mixed with the fibrous fraction. The mixture is left overnight at room temperature and then transferred to the first washing stage 16, where water is added through line 40 and mixed with the mixture. The mixture is then transferred to the first liquid removal stage 18, where the liquid is pressed from the fibrous fraction using a 100 to 200 micron screen. However, a roller screen press will also be suitable. The liquid is removed along line 42.

The fibrous fraction is transferred to the second digesting and bleaching stage 20 and sodium hydroxide and hydrogen peroxide are fed respectively along lines 44 and 46 and mixed with the fibrous fraction. The mixture is again left at room temperature overnight before being transferred to the second washing stage 22, where water is added to the fibrous fraction along the water feed line 48. The water is well mixed with the fibrous fraction and the mixture is then transferred to the second liquid removal stage 24, where the liquid is pressed from the fibrous fraction and removed along line 50.

Once transferred to the neutralising stage 26, water and 32% hydrochloric acid are respectively added to the fibrous fraction through the lines 52 and 54 and mixed with the fibrous fraction under stirring. When the colour of the fibres of the fibrous fraction has turned to a satisfactorily light colour, i.e. from yellow to off-white, the mixture is transferred to the third liquid removal stage 28 where the liquid is pressed from the fibrous fraction and removed along line 56. The fibrous fraction, at a pH of between about 5 and about 7, is then transferred to the drying stage 30, where the fibres are dried. Fibres can be dried using a flaker (roller dryer) comprising of a fibre pulp running over heated drums in a thin layer. Drying is achieved while the fibres are in contact with the drums before being scraped off in flaked layers. Drying can also be achieved in a rotary kiln dryer. After excess moisture is pressed from the fibres, the fibres are blown dry with hot air in a rotating cylindrical drum while the fibres are moved slowly from the beginning to the end of the drum using baffles. The rotating action of the moving drum allows fibres to come into contact with hot air without sticking to the sides of the drum. The fibres are then transferred to the milling stage 34, where the fibres are milled to a desired size.

It is to be appreciated that an additional bleaching step can be incorporated into the process 10 before the neutralising stage 26. This will typically produce a product which is whiter and at a lower pH.

### Example 1

1 kg of brewer's spent grain was treated with the process 10, as illustrated, and 0.05 kg of sodium hydroxide and 0.03 kg of 50% hydrogen peroxide were added to the first digesting and bleaching stage 14. 7 litres of water were added to the first washing stage 16. 0.05 kg of sodium hydroxide and 0.03 kg of 50% hydrogen peroxide were added to the second digesting and bleaching stage 20 and 7 litres of water were added to the second washing stage 22. To the neutralising stage 26, 500 g of water and 0.07 kg of 2N hydrochloric acid were added.

It was found that the fibrous fraction from the brushing stage 12 comprised an increased dietary fibre content of about 20% by mass (20 g/100 g wet brushed brewer's spent grain), instead of the typical 14% by mass (14 g/100 g wet unbrushed brewer's spent grain) of conventional processes. 146 g (71% yield based on starting material dietary fibre content) of dry bleached fibre was obtained from 1 kg of wet brushed brewer's spent grain. By analysing the brewers spent grain for dietary fibre and protein contents, it was found that untreated brewers spent grain always has an average total dietary fibre:protein ratio of approximately 3:1 (see Table 1 for four examples of analytical data on brewers spent grain before any brushing treatment). After the brushing treatment, it was found that the ratio of total dietary fibre:protein has increased to 6.8:1 in the coarse brushed fibrous fraction and thereby supporting the finding of increased dietary fibre content.

By using the ratio of total dietary fibre:protein, the effect of moisture differences in the material is excluded. Additionally, it was also found that the aperture size of the sieve (perforated drum 17) used in the brush pulper 13 has an optimum range for a specific cereal. For barley spent grain, the final dietary fibre content of the dried fibre fraction is 75% (dry base) with a sieve size of 1 mm, while larger (1.5 mm) or smaller (0.4 mm) sieve sizes only give dietary fibre contents of 66% (dry base). It is envisaged that typical sieve aperture sizes for ranges of spent grain types including types from different cereals and legumes will vary between 0.3 and 3 mm with an optimum size for each cereal type ensuring optimum separation of proteinaceous and fibre fractions. The dietary fibres produced had a water absorption of 6.00 g water per gram of dry fibres, a pH of about 5.8 and a colour which was light tan to off-white, depending on the particle size distribution.

TABLE 1
Analytical data on four batches of brewer's
spent grain before brushing

| | | | | Total dietary |
|---|---|---|---|---|
| | Total dietary | Moisture | Protein | fibre:protein |
| Sample no* | fibre (g/100 g) | (g/100 g) | (g/100 g) | ratio |
| A | 13.6 | 77.9 | 4.65 | 2.92:1 |
| B | 12.7 | 79.2 | 3.95 | 3.22:1 |
| C | 8.1 | 86.4 | 2.4 | 3.37:1 |
| D | 17.2 | 71.6 | 5.5 | 3.12:1 |
| Average | | | | 3.16:1 |

### Example 2

20-25 kg batches of barley brewers spent grains (BSG) with moisture content between 70 and 75% were treated using the one-step wet brushing technique of the invention. 400 to 600 g of water was added for each kg of wet BSG during brushing. The purpose of the water is for transport through the brush pulper. A 1 mm sieve aperture size was used. The BSG was divided by means of the brushing into two streams namely a high fibre stream and a high protein stream.

The proximate composition of the BSG (dry base) before brushing was:

Protein: 21.9%

Fat: 9.1%

Crude Fibre: 16.9%

Ash: 3.3%

The proximate composition of the dried high protein stream after brushing was:

Protein: 41.9%

Fat: 11.6%

Crude Fibre: 4.6%

Ash: 4.6%

The proximate composition of the dried high fibre stream after brushing was:

Protein: 12.6%

Fat: 7.3%

Crude Fibre: 22.2%

Ash: 3.1%

The proximate composition of a dried bleached high fibre stream using a typical dried high fibre stream as described above in this Example followed by bleaching as described in Example 1 was:

Protein: 1.5%

Fat: 3.7%

Dietary Fibre: 79.2%

Crude Fibre: 47.3%

Ash: 5.6%

Bleaching therefore removed additional protein and further increased fibre content of the high fibre stream. Solubilised protein was washed from the bleached fibres and can be recovered as well.

Losses in this process are minimal as no material is being discarded and the only losses are ascribed to material stuck in the machine after shutdown. Continuous operations will produce minimal or negligible losses.

The two streams can be used as is (in the wet state) for further processing such as in animal feed formulations, extraction of protein, and bleaching of the fibre, or the streams can be dried using tunnel, drum, rotary kiln or other suitable conventional driers.

It is an advantage of the process 10, as illustrated, that it is suitable for treating brewer's spent grain to obtain dietary fibre and/or a protein-rich product. The typical protein content of untreated, i.e. unbrushed, germinated grains after removal of a starch portion during a brewing or fermentation stage is between 15% and 30%. These levels are too low for useful substitution of for example fish meal, which typically contains 40%-60% protein. A liquid phase with suspended proteinaceous material cannot be separated from brewer's spent grain without mechanical scrubbing from the husks as pressing alone does not work due to proteinaceous material being stuck to the husks. The process 10 thus employs both scrubbing and pressing to separate proteinaceous material and fibrous material. The process 10, as illustrated, provides a dietary fibre recovery from brewer's spent grain which is up to about 40% more than for conventional processes. The dietary fibres can replace products from wood or bamboo, and originate from a waste product compared to for example bamboo plantations. The protein-rich product is also a value-added product due to the significantly increased protein content thereof.

On a dry base calculation, the amount of dietary fibre material in the high fibre stream will increase from typically about 50% to up to 75%, depending on the sieve size used in the brushing or combing process, while crude fibre will increase from 17-19% to about 25% (crude fibre is included in dietary fibre). At the same time, protein typically decreases from about 21% to 11% in the high fibre stream. Simultaneously, the amount of protein in the high protein stream increases from 15%-30%, typically 21-25%, up to 40-60%, typically 40-50%, while the crude fibre decreases from about 17-19% to 8% or less, usually less than 5%. The low crude fibre level is significant for providing a useful product suitable for the replacement of expensive high protein ingredients in animal feeds such as fish meal, as crude fibre is undesirable in some feeds such as feeds for carnivorous fish.

Such changes in composition of the processed streams are significant in the pre-processing stage of spent grains intended for further value addition such as usage in animal feeds, dietary fibres for human consumption, purified proteins for the manufacture of bioplastics, or for food and medical coatings applications, and second generation bio-ethanol production from the dietary fibres stream. The cleaned fibres are highly suitable for second generation bio-ethanol production as the dietary fibre is available for enzymatic and acid conversion to fermentable sugars, without being hampered by high levels of protein. Although changes might seem small, they are highly significant downstream because significantly less chemicals are then used for further purification in all of the abovementioned processes. In the case of the protein stream, the significantly lowered crude fibre content and significantly higher protein content allow for direct replacement of scarce and expensive protein streams such as fish meal, which has a high protein content and low crude fibre content. The invention provides for a very cost effective one-step wet separation process suitable for immediate upstream separation of the spent grain into two useful streams for various types of further downstream processing which is otherwise uneconomical on the unseparated waste product, and which requires relatively small amounts of water compared to dry milling and sieving techniques.

1. A process for obtaining a valuable product from plant material which includes predominantly grain and comprising both proteinaceous material and fibrous material, the process including
in a separation stage, brushing or scrubbing the plant material in a wet condition against a separation medium, thereby forcing proteinaceous material through the separation medium and retaining fibrous material on the separation medium; and
withdrawing a fibre-rich product and a protein-rich product from the separation stage.

2. The process as claimed in claim 1, in which the plant material includes predominantly grain from the grass family and/or from the legume family.

3. The process as claimed in claim 1, in which the plant material is brewer's spent grain.

4. The process as claimed in claim 1, which includes digesting and bleaching the fibre-rich product.

5. The process as claimed in claim 4, in which the fibre-rich product is simultaneously digested and bleached with an aqueous solution that includes a digesting agent and a bleaching agent.

6. The process as claimed in claim 4, in which the digesting and bleaching of the fibre-rich product is effected at room temperature and at atmospheric pressure.

7. The process as claimed in claim 1, in which the separation medium is in the form of a hollow perforated cylindrical drum, the plant material being brushed or scrubbed with at least one brush against an interior surface of the hollow perforated cylindrical drum.

8. The process as claimed in claim 1, in which the separation medium has apertures with a maximum dimension of no more than 3 mm.

9. The process as claimed in claim 8, in which the apertures have a maximum dimension in the range of 0.3 to 3 mm.

10. The process as claimed in claim 1, in which the plant material has a moisture content of at least 70%.

11. The process as claimed in claim 1, which includes feeding the plant material into the separation stage as an aqueous feed stream, with the fibre-rich product being withdrawn from the separation stage as an aqueous product stream.

12. The process as claimed in claim 11, in which the aqueous feed stream includes water obtained from a brewing process, with said water thus forming part of the aqueous product stream.

13. The process as claimed in claim 12, in which the water and fibre-rich product of the aqueous product stream are separated, with the water being added to the protein-rich product.
